(19) United States
(12) Patent Application Publication
(10) Pub. No.: US 2023/0176925 A1
(43) Pub. Date: Jun. 8, 2023

(54) MANAGING MULTIPLE VIRTUAL PROCESSOR POOLS

(71) Applicant: International Business Machines Corporation, Armonk, NY (US)

(72) Inventors: Seth E. Lederer, Staatsburg, NY (US); Jeffrey G. Chan, Fishkill, NY (US); Hunter J. Kauffman, Poughkeepsie, NY (US); Jeffrey Paul Kubala, Poughquag, NY (US); Daniel Henry Lepore, Austin, TX (US)

(21) Appl. No.: 17/542,763

(22) Filed: Dec. 6, 2021

(51) Int. Cl. G06F 9/50

(52) U.S. Cl. CPC G06F 9/5077; G06F 9/5033; G06F 9/5044; G06F 2209/5011

(57) ABSTRACT

A computer implemented method for managing virtual processor pools includes identifying a set of available system resources, defining a set of virtual resource pools, assigning one or more system resources of the set of identified system resources to one or more virtual pools of the set of virtual resource pools, creating a plurality of logical partitions within a first virtual resource pool of the set of virtual resource pools, wherein each logical partition of the plurality of logical partitions specifies a weight relative to other partitions in the first virtual resource pool, receiving a request for additional resources from the first virtual resource pool, and allowing the first virtual resource pool to access an unused resource from a second virtual resource pool of the set of virtual resource pools. A computer program product and computer system corresponding to the method are also disclosed herein.

### BACKGROUND

The present invention relates to the field of shared processing, and more specifically to managing virtual processor pools.

Software multitenancy is a software architecture in which a single instance of software runs on a server and serves multiple tenants. Systems designed in such a manner are “shared” rather than “dedicated” or “isolated”. A tenant may refer to a group of users who share common access with specific privileges to the software instance. With a multitenant architecture, a software application is designed to provide every tenant a dedicated share of the instance—often including its data, configuration, user management, tenant individual functionality, and non-functional properties as well. Multitenancy contrasts with multi-instance architectures, where separate software instances operate on behalf of different tenants.

Multitenancy support for cloud providers is a complex area to manage in terms of CPU “guarantees” for a particular client. Often a client has a need for multiple virtual machines or logical partitions, and the client/cloud provider contract for a certain amount of CPU horsepower to be available/delivered to their collection of logical partitions. These partitions can vary in size, CPU requirements, and importance to a client. In some systems, priority is assigned according to a number of logical cores assigned to a partition and a relative share (or weight) for the logical partition. This weight is relative to all other partitions currently being hosted in that server configuration, so any changes to said weights need to consider the entire set of active partitions.

### SUMMARY

As disclosed herein, a computer implemented method for managing virtual processor pools includes identifying, by one or more processors, a set of available system resources, defining, by one or more processors, a set of virtual resource pools, assigning, by one or more processors, one or more system resources of the set of identified system resources to one or more virtual pools of the set of virtual resource pools, creating, by one or more processors, a plurality of logical partitions within a first virtual resource pool of the set of virtual resource pools, wherein each logical partition of the plurality of logical partitions specifies a weight relative to other partitions in the first virtual resource pool, receiving, by one or more processors, a request for additional resources from the first virtual resource pool, and allowing, by one or more processors, the first virtual resource pool to access an unused resource from a second virtual resource pool of the set of virtual resource pools. A computer program product and computer system corresponding to the method are also disclosed herein.

### BRIEF DESCRIPTION OF THE DRAWINGS

FIG. 1 depicts a shared processing system in accordance with an embodiment of the present invention;

FIG. 2 is a flowchart depicting a shared processing method in accordance with an embodiment of the present invention;

FIG. 3A depicts one example of processor distribution in the absence of virtual processor pools in accordance with an embodiment of the present invention;

FIG. 3B depicts one example of processor distribution in the absence of virtual processor pools in accordance with an embodiment of the present invention;

FIG. 3C depicts one example of processor distribution in the absence of virtual processor pools in accordance with an embodiment of the present invention;

FIG. 4A depicts one example of processor distribution in accordance with an embodiment of the present invention;

FIG. 4B depicts one example of processor distribution in accordance with an embodiment of the present invention; and

FIG. 5 represents a computerized system, suited for implementing one or more method steps as involved in the present subject matter.

### DETAILED DESCRIPTION

With respect to multi-tenancy support for cloud providers, a particular client may want to change weights or importance of its set of logical partitions being hosted in a server configuration. Further, the client may even want to add or remove partitions for their current server configuration while still maintaining a same level of total CPU horsepower enabled or provided according to a contract. Considering that cloud providers may provide support for a multitude of clients, accommodating all clients with similar but separate needs in a server configuration can make managing weights for the collective server configuration particularly cumbersome.

Embodiments of the present invention generate and manage a virtual processor pool rather than a completely segregated physical processor pool, wherein the virtual processor pool assigns a subset of the count of available machine CPUs (or other resources) to a virtual pool, for example, for a particular client. The client is then free to assign weights to their collection of logical partitions in the virtual pool. Those weights, relative to the other members of the virtual pool, determine how the collective CPU horsepower (in terms of counts of physical CPUs) will be assigned to their logical partitions. The other partitions currently on the machine determine their priority separately based on their weights and the remaining CPUs on the machine. In embodiments where multiple virtual pools are present on a single server, each can be managed for priority separately. Embodiments of the present invention configure weight/priority management relative to individual processor entitlements, meaning there is no requirement to actually segregate the pools and force only pool members to run on a particular set of physical CPUs. Therefore, the host is not prevented from optimizing workloads such that pool member workloads or tasks may be migrated towards a separate (external) set of processors if necessary.

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

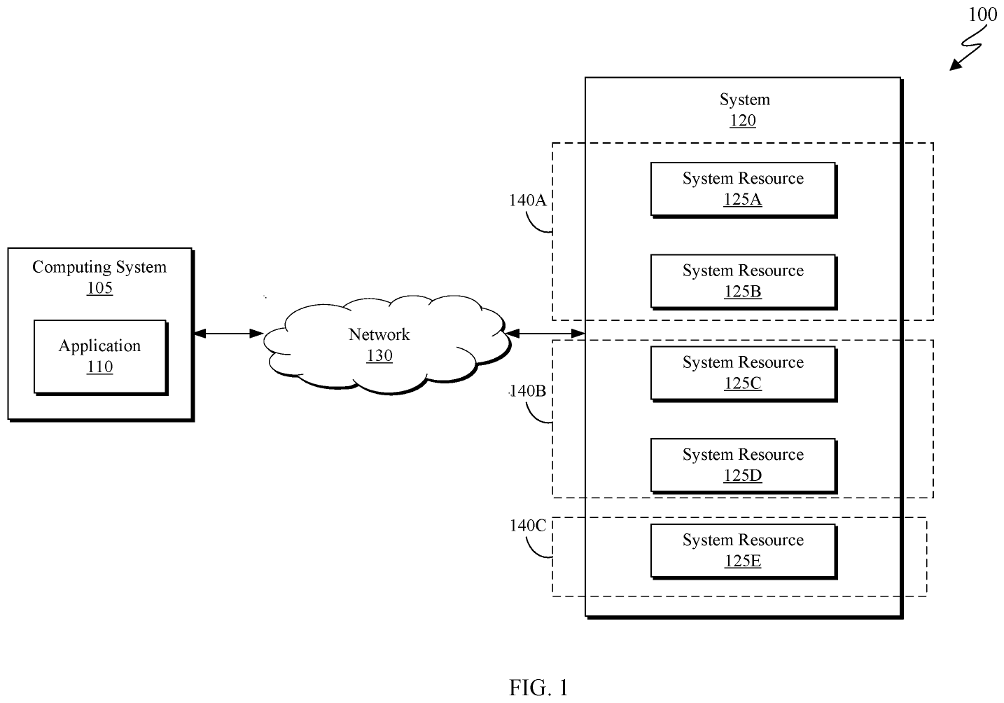

FIG. 1 depicts a shared processing system 100 in accordance with an embodiment of the present invention. As depicted, shared processing system 100 includes computing system 105, application 110, system 120, and network 130, wherein system 120 comprises a plurality of system resources 125A, 125B, 125C, 125D, and 125E, and wherein the plurality of system resources are split amongst virtual processor pools 140A, 140B, and 140C. The set of system resources 125A, 125B, 125C, 125D, and 125E may be referred to generally as “system resources 125”, and it should be appreciated that a set of system resources may include any configuration of system resources, not merely the configuration depicted. Similarly, the set of virtual processor pools 140A, 140B, and 140C may be referred to generally as “virtual processor pools 140”, and it should be appreciated that a set of virtual processor pools may include any configuration or grouping of processors, not merely the configuration depicted.

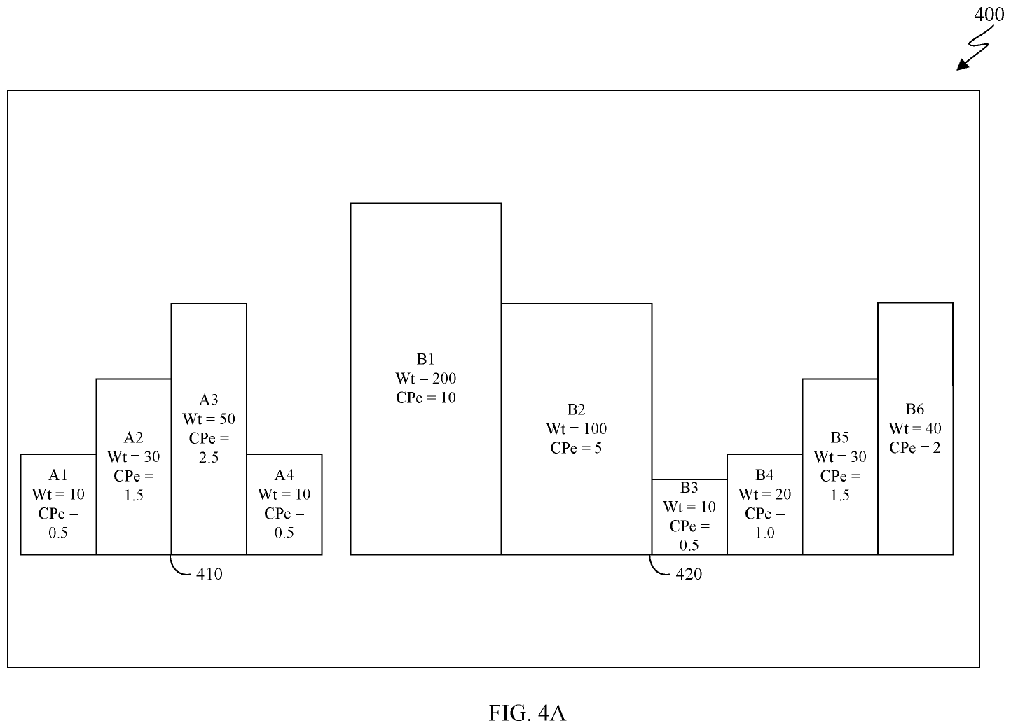

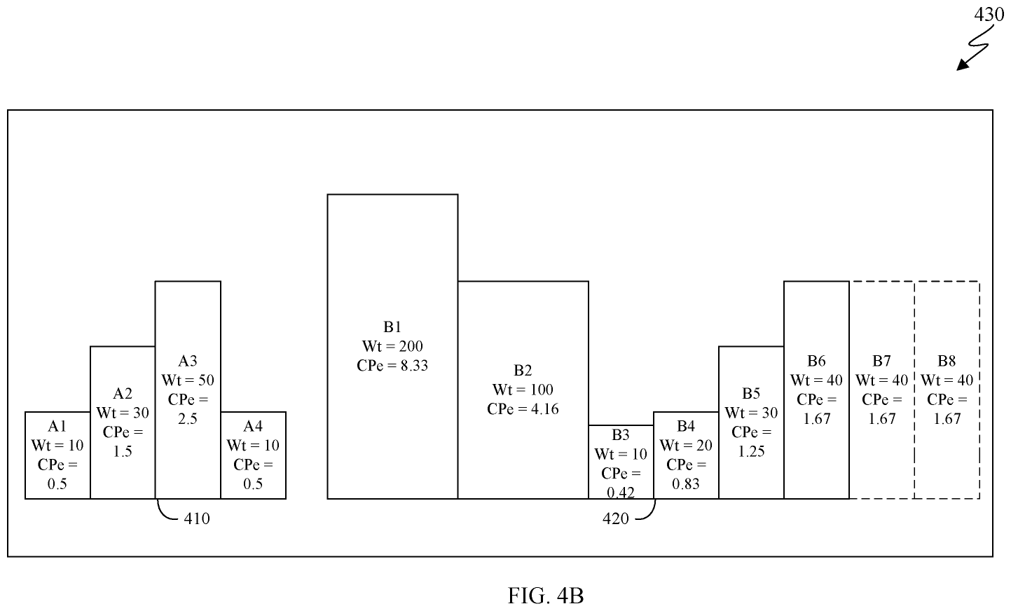

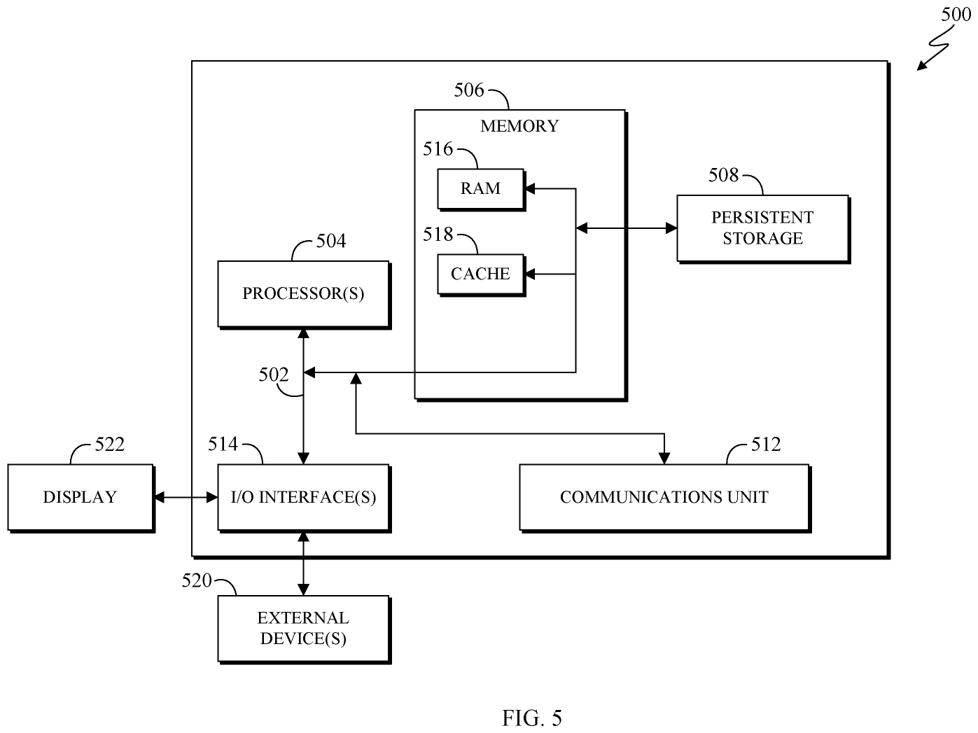

Computing system 105 can be a desktop computer, a laptop computer, a specialized computer server, or any other computer system known in the art. In some embodiments, computing system 105 represents computer systems utilizing clustered computers to act as a single pool of seamless resources. In general, computing system 105 is representative of any electronic device, or combination of electronic devices, capable of receiving and transmitting data, as described in greater detail with regard to FIG. 4. Computing system 105 may include internal and external hardware components, as depicted and described in further detail with respect to FIG. 5.

Application 110 is an application configured to manage shared resources within a processing environment such as shared processing system 100. In at least some embodiments, application 110 is configured to communicate with one or more systems comprising one or more system resources to allocate said resources according to needs within the processing environment. In other words, with respect to the depicted embodiment, application 110 is configured to communicate with system 120 via network 130 to allocate resources system resources 125 according to needs a client has imposed on the system. As depicted, system resources 125 have been divided amongst virtual processor pool 140A, 140B, and 140C. In at least some embodiments, application 110 is configured to receive a request for additional resources (via network 130) from one of virtual processor pools 140A, 140B, or 140C. In such embodiments, application 110 may additionally be configured to determine whether either of the virtual processor pools 140 not initiating the request has unused system resources. In embodiments where one of the virtual processor pools 140 has at least one unused system resource 125, said virtual processor pool 140A may be configured to provide said unused system resource 125A to the virtual process pool 140 requesting additional resources. In some embodiments, virtual processor pools 140 are configured to provide resources directly to one another; in other embodiments, virtual processor pools 140 communicate and provide system resources to one another strictly via application 110. In at least some embodiments, each virtual processor pool 140 corresponds to a particular client; in other words, virtual processor pool 140A corresponds to a first client, virtual processor pool 140B corresponds to a second client, and virtual processor pool 140C corresponds to a third client. In such embodiments, the allocation of system resources 125 amongst virtual pools 140 may be defined according to the resources required to be provided to each client according to one or more contracts. In some embodiments, each virtual processor pool 140 may have its own management application or an application configured to communicate on its behalf; in other embodiments, management and communication on behalf of the virtual processor pools 140 are handled by application 110.

Network 130 can be, for example, a local area network (LAN), a wide area network (WAN) such as the Internet, or a combination of the two, and include wired, wireless, or fiber optics connections. In general, network 130 can be any combination of connections and protocols that will support communications between any of computing system 105 and components of system 120, such as virtual processor pools 140 and system resources 125.

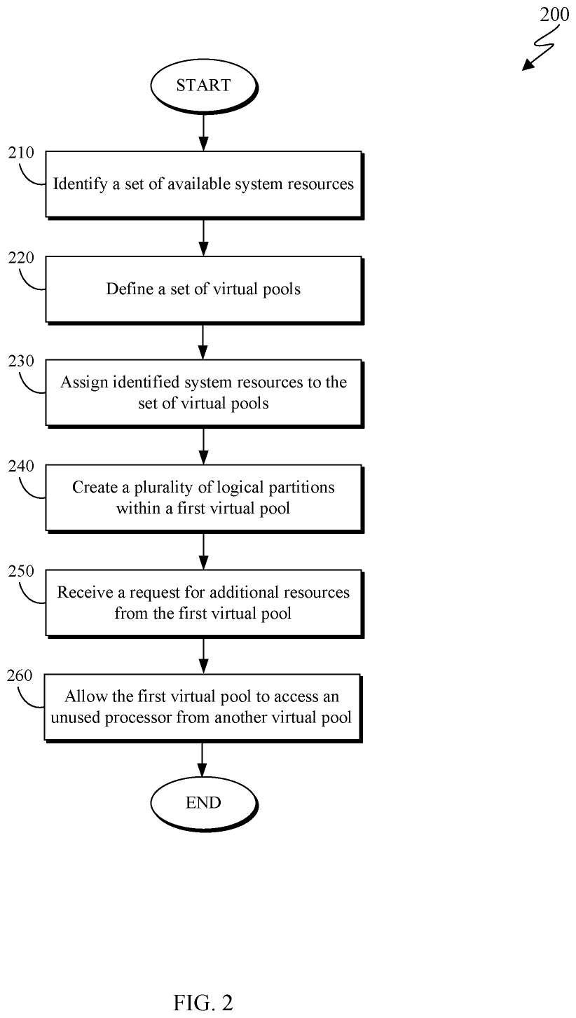

FIG. 2 is a flowchart depicting a shared processing method 200 in accordance with an embodiment of the present invention. As depicted, shared processing method 200 includes identifying (210) a set of available system resources, defining (220) a set of virtual pools, assigning (230) identified system resources to the set of virtual pools, creating (240) a plurality of logical partitions within a first virtual pool, receiving (250) a request for additional resources from the first virtual pool, and allowing (260) the first virtual pool to access an unused resource from another virtual pool. In general, shared processing method 200 may enable simplified client manipulation and increased granularity with respect to multi-tenancy processing environments.

FIG. 2 and shared processing method 200 are described generally with respect to “system” resources. With respect to certain embodiments of the present invention, shared processing method 200 is directed specifically towards processors and CPUs, while other embodiments are directed towards memory units. Generally, the embodiment(s) described below are defined with respect to generic “system” resources which should be understood to encompass any resources available via computing system environments. With respect to at least one embodiment of the present invention, system resources correspond to Integrated Facility for Linux (IFL) processors.

Identifying (210) a set of available system resources may include identifying or selecting a system (or systems) of interest. In at least some embodiments, identifying (210) a set of available system resources includes identifying a set of system resources capable of contributing to a task or task type of interest. Identifying (210) a set of available system resources may include analyzing system resources to determine whether or not each resource is currently assigned to a task, client, contract, or other commitment. In at least some embodiments, resources which are currently occupied with a current task are excluded from the set of available system resources. In other embodiments, resources which are currently occupied with a current task may be included in the set of available system resources if it can be determined that they are unavailable strictly in the short term; in other words, a system resource nearing completion of its task or assigned a single (non-recurring) task may still be included in the set of available resources given its pending availability. In other words, identifying (210) a set of available resources includes determining which resources are not reserved, and may also include determining which resources are not on stand-by. Generally, identifying (210) a set of available system resources includes identifying those system resources which may be included in virtual pools for the execution of upcoming task requests. Identifying (210) a set of available system resources may include identifying resources hosted in any location which the system of interest has the ability to access and utilize.

Defining (220) a set of virtual pools may include creating one or more virtual pools intended to include one or more system resources. Defining (220) a set of virtual pools may include defining a virtual pool with respect to each client, contract, or entity serviced by the system of interest. It should be appreciated that while the exemplary embodiments described within generally refer to a one virtual pool per client definition, defining (220) a set of virtual pools can alternately include defining multiple virtual pools to apply to a single client, contract, or entity serviced. Additionally, in yet other embodiments defining (220) a set of virtual pools may occur independent of client needs, and may instead simply divvy up existing processors into common sized groups ready to be allocated as necessary. In at least some embodiments, defining (220) a set of virtual pools additionally includes naming each virtual pool of the set of virtual pools such that each pool is identifiable by name. In at least some embodiments, especially those where specific client needs are known at this point, defining (220) a set of virtual pools additionally includes defining total resource requirements with respect to each pool based on the needs of the corresponding client/contract/entity. Defining (220) a set of virtual pools may additionally include defining a set of activation rules corresponding to resources within the pools

Assigning (230) identified system resources to the set of virtual pools may include assigning a subset of the total identified available system resources to each virtual pool of the set of virtual pools. In some embodiments, assigning (230) identified system resources to the set of virtual pools includes assigning each identified system resource to a virtual pool, such that none of the identified system resources are left without an assigned virtual pool. In such embodiments, the sum of the physical resources across all the virtual pools should equal the total resources available on the server. In other embodiments, assigning (230) identified system resources to the set of pools includes assigning the identified system resources to the set of pools until each pool has a required number of resources. In such embodiments, the unassigned identified system resources remain in what may be referred to as the “base pool”. In general, the sum of the physical resources across all the virtual pools cannot exceed the total resources available in the server.

Creating (240) a plurality of logical partitions within a first virtual pool may include activating one or more partitions according to any present activation rules with respect to the first virtual pool. Creating (240) a plurality of logical partitions within a first virtual pool may include assigning weights to each logical partition, wherein the weight indicates a priority corresponding to said logical partition with respect to other partitions in the virtual pool. In at least some embodiments, creating (240) a plurality of logical partitions within a first virtual pool includes defining each partitions CPU entitlement according to the following equation:

$$CPUEntitlemen {t}_{lp} = \frac{( {LogicalCPWeight}_{lp} * {SharedPhysicalCPs}_{pool} )}{( \sum {WeightAllLPs}_{pool} )}$$

It should be noted that the inverse of CPUEntitlement can be used as an Expansion Factor to apply to utilized CPUTime to form EffectiveTime for a logical core and/or logical partition to determine how much of its entitlement has been used as well as current priority for selection to be dispatched on a physical core next. ExpansionFactor and EffectiveTime may be calculated according to the following equations:

$$ExpansionFacto {r}_{lp} = \frac{( \sum WeightAllLP {s}_{pool} )}{( LogicalCPWeigh {t}_{lp} * {SharedPhysicalCPs}_{pool} )}$$

$$EffectiveTim {e}_{n} = CPUTim {e}_{n} * ExpansionFacto {r}_{n}$$

It should be noted that the use of “lp” in these formulas can represent either a single logical core or a collection of logical cores for a logical partition. In other words, management of this type can be executed at a logical core level or a logical partition level. An expansion factor of 1.0 for a logical core indicates the logical core is entitled to an entire physical core. EffectiveTime for such a logical core tracks exactly with consumed CPUTime for the logical core. Accordingly, such a logical core should be able to be dispatched whenever it needs to. With respect to the above equations, the use of “CP” represents computer processors, though it should be appreciated that such variable instances can be swapped out for any resource of interest in other embodiments.

If a logical core is entitled to 0.5 of a physical core, its expansion factor would be 2.0. For each consumed unit of CPUTime with respect to such a logical core, it would be ‘charged’ twice that amount in its EffectiveTime because of the expansion factor. Therefore, recent history of consumed EffectiveTime can be used to determine current priorities for the logical cores in the pool and, since all weights and priorities have been scaled to physical processors, the priorities can be enforced across the entire server with these values without having to physically segregate physical cores to individual pools.

Receiving (250) a request for additional resources from the first virtual pool may include receiving a request from an application or resource responsible for managing the first virtual pool indicating that the first virtual pool's current or pending workload requires the use of additional resources beyond the currently allocated resources. In at least some embodiments, receiving (250) a request for additional resources includes receiving a request indicating one or more specific resource types and corresponding resource amounts required, as well as an anticipated duration for which the additional resource(s) would be required. In at least some embodiments, receiving (250) a request for additional resources from the first virtual pool includes receiving an indication of which other virtual pools to request additional resources from. In other embodiments, receiving (250) a request for additional resources from the first virtual pool does not include any indication of which other virtual pools to request additional resources from. The latter embodiments enable additional resources to be requested without requiring knowledge of the specifics of the other virtual pools. In at least some embodiments in which a resource beyond the scope of the virtual pools is requested, the request may not be fulfilled.

Allowing (260) the first virtual pool to access an unused resource from another virtual pool includes identifying an unused system resource with respect to a different virtual pool. In at least some embodiments, allowing (260) the first virtual pool to access an unused resource from another virtual pool includes allowing the first virtual pool to assign one or more tasks to the identified unused system resource. In such embodiments, the first virtual pool additionally provides any data or other task information required to complete the task to the identified unused system resource, such that said system resource may be utilized to handle the task overflow that extends beyond the capabilities or availability of the current virtual pool. In some embodiments, allowing (260) the first virtual pool to access an unused resource from another virtual pool includes reassigning the unused resource to the virtual pool by definition. In other embodiments, allowing (260) the first virtual pool to access an unused resource from another virtual pool includes utilizing the unused resource to execute a task assigned to the first virtual pool, but retaining the current structure in which the unused resource is assigned to a separate virtual pool.

With respect to the above embodiments, it should be appreciated that in some cases, modifying one or more features of the plurality of logical partitions within a first virtual resource pool will not change the features of the partitions of a second virtual pool. In other words, changes made with respect to features of partitions in one pool are completely independent from those features in other pools. Consider an embodiment in which two virtual pools are managed by two separate clients; managing features independently in this manner ensures that changes made by a first client with respect to features of their corresponding pool do not inadvertently impact features of the pool corresponding to the second client.

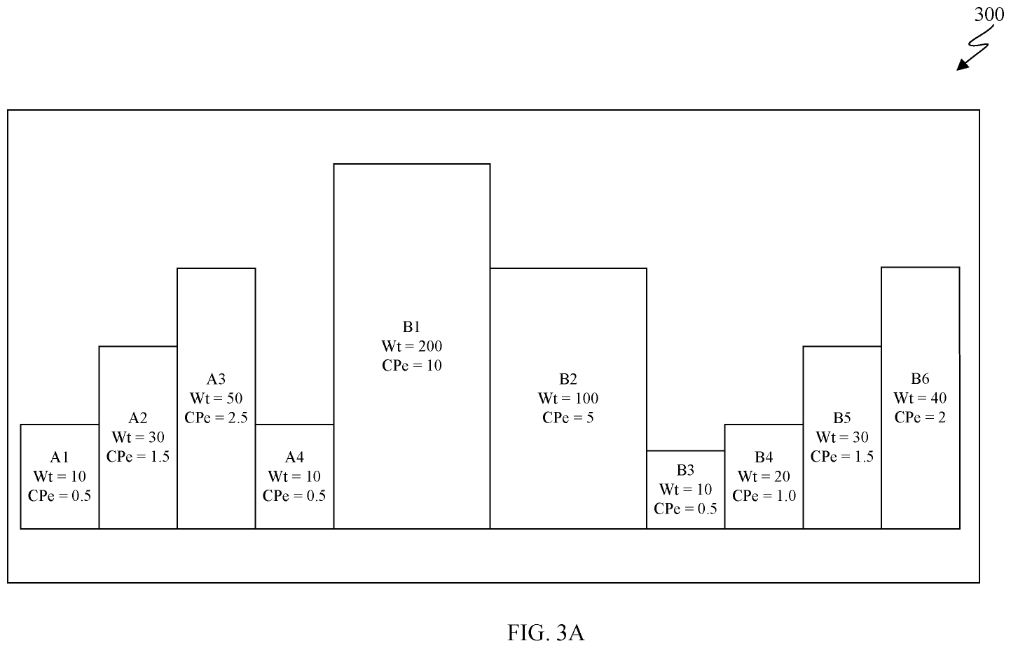

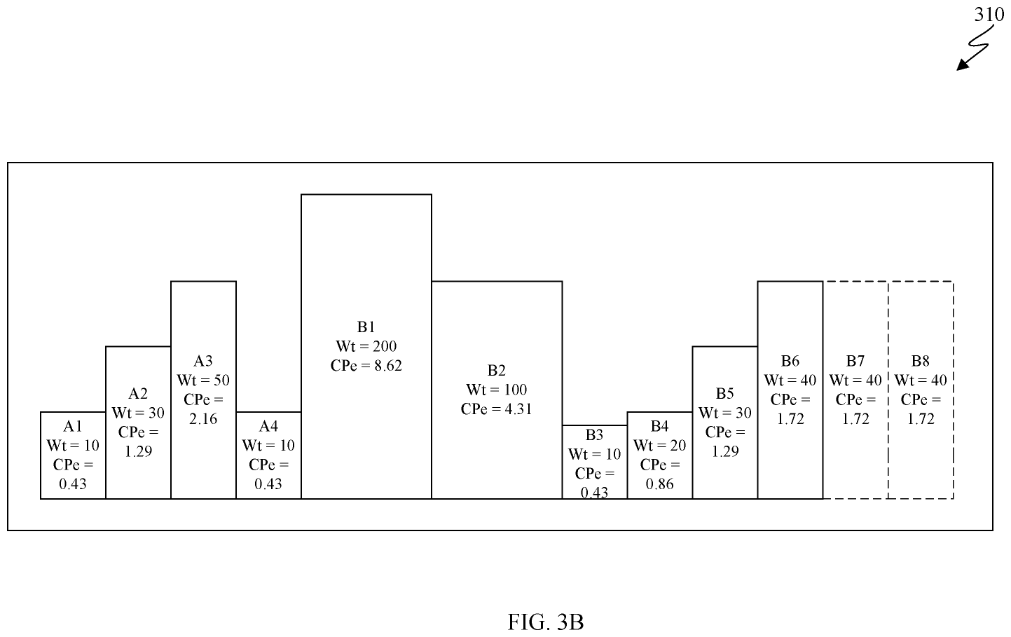

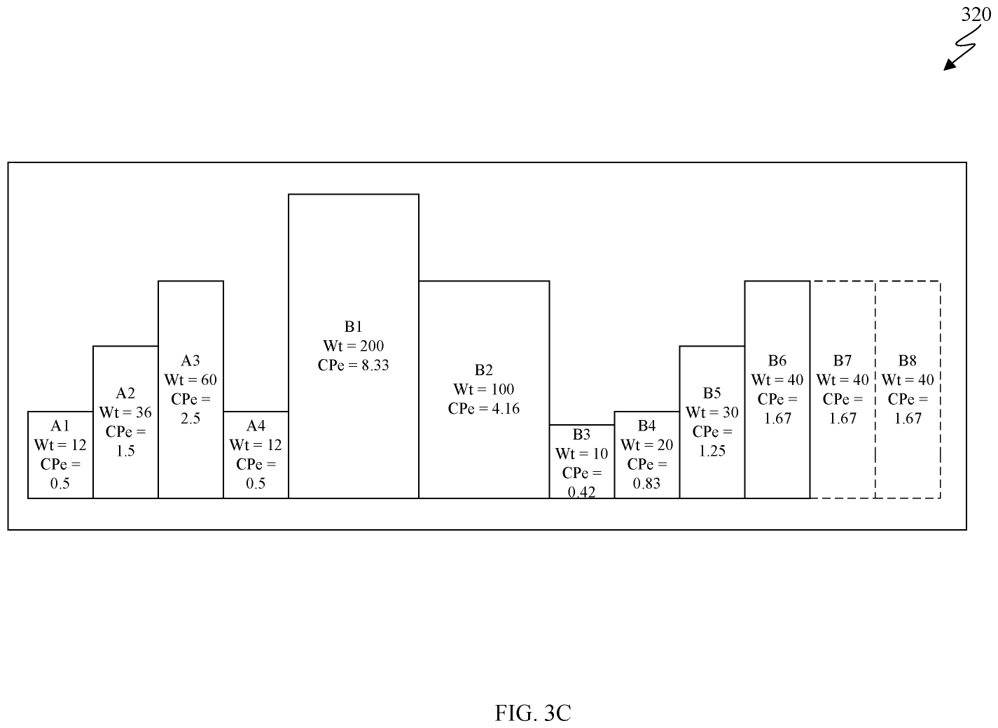

FIG. 3A depicts one example of processor distribution 300 in the absence of virtual processor pools in accordance with an embodiment of the present invention. As depicted, processor distribution 300 includes 4 partitions from a first client (labeled A1 through A4) requiring 5 processing units across their partitions as defined (indicated by CPe=X). Similarly, processor distribution 300 includes 6 partitions corresponding to a second client (labeled B1 through B6) requiring 20 processing units across the partitions as defined. As indicated, the total weight across all of the processing units is 500.

FIG. 3B depicts a processor distribution 310 which builds upon the processor distribution 300, still in the absence of virtual processor pools, in accordance with an embodiment of the present invention. Processor distribution 310 depicts an example embodiment in which the second client wants to add two additional partitions similar to partition B6 with respect to processor distribution 300. As depicted, the new total weight across all of the processing units becomes 580 with the two added partitions, but the processing unit distribution must shift to accommodate the newly added partitions. The second client (responsible for the B partitions) may accept this reallocation, but the first client's partitions (the A partitions) also cede processing units to accommodate the newly added workload.

FIG. 3C depicts a processor distribution 320 which builds upon processor distribution 300 and processor distribution 310, still in the absence of virtual processor pools, in accordance with an embodiment of the present invention. Processor distribution 320 depicts an example reconfiguring of the weights of the depicted partitions to ensure that the first client's partitions (A1 through A4) get their required processing units, yielding a new total weight of 600.

FIG. 4A depicts a processor distribution 400 with the same clients, partitions, and client needs as processor distribution 300; however, processor distribution has been divided into virtual processor pool 410 and virtual processor pool 420 according to the client split. As depicted, processor distribution 400 includes 4 partitions from a first client (labeled A1 through A4) requiring 5 processing units across their partitions as defined (indicated by CPe=X). Similarly, processor distribution 400 includes 6 partitions corresponding to a second client (labeled B1 through B6) requiring 20 processing units across the partitions as defined. As indicated, the total weight across all of the processing units is 500.

FIG. 4B depicts a processor distribution 430 which builds upon the processor distribution 400. Processor distribution 430 depicts an example embodiment in which the second client wants to add two additional partitions similar to partition B6 with respect to the processor distribution 400. As depicted, the new total weight across all of the processing units becomes 580 with the two added partitions, but the processing unit distribution must shift to accommodate the newly added partitions. However, in the presence of virtual processor pool 410 and virtual processor pool 420, only the processing entitlements with respect to the second client (and the B partitions) and virtual processor pool 420 are adjusted. Therefore, the necessary entitlements for the first client with respect to virtual processor pool 410 are retained, and the total weight only jumps to 580, rather than 600 as described with respect to the embodiment depicted in FIG. 3C. Notably, only altering the weight of virtual processor pool 420 to accommodate the additional partitions (to 480) enables the weight of virtual processor pool 410 to stay the same at 100, ensuring that the additional partition load in virtual processor pool 420 does not impact features of virtual processor pool 410.

With respect to the embodiment described with respect FIGS. 4A and 4B, virtual processor pool 410 does not contain any unused processors, and therefore cannot simply allow virtual processor pool 420 to access such unused processors to manage additional workload; thus, the reallocation of processors within virtual processor pool 420 is required. Consider an alternative embodiment instead in which the first client's virtual processor pool contains a plurality of unused processors; in such an embodiment, the first client's virtual processor pool could receive a request from the second client's virtual processor pool for access to said unused processors. The first client's virtual processor pool, upon receiving said request, may verify the availability of said plurality of unused processors, and upon confirming the availability of said plurality of unused processors, the first client's virtual processor pool may provide access to said plurality of unused processors to the second client's virtual processor pool. In such an embodiment, “access” to said plurality of unused processors may be limited to a period of time required to complete the additional workload. Additionally, “access” to said plurality of unused processors may include enabling the second client to manage the allocation of said additional workload; in other embodiments, however, the first client retains management of the unused processors, and simply receives and processes the second client's requests and directions to allocate the unused processors to the additional workload.

FIG. 5 depicts a block diagram of components of a computing system in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

As depicted, the computer 500 includes communications fabric 502, which provides communications between computer processor(s) 504, memory 506, persistent storage 508, communications unit 512, and input/output (I/O) interface(s) 514. Communications fabric 502 can be implemented with any architecture designed for passing data and/or control information between processors (such as microprocessors, communications, and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 516 and cache memory 518. In general, memory 506 can include any suitable volatile or non-volatile computer-readable storage media.

One or more programs may be stored in persistent storage 508 for access and/or execution by one or more of the respective computer processors 504 via one or more memories of memory 506. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage 508.

Communications unit 512, in these examples, provides for communications with other data processing systems or devices. In these examples, communications unit 512 includes one or more network interface cards. Communications unit 512 may provide communications through the use of either or both physical and wireless communications links.

I/O interface(s) 514 allows for input and output of data with other devices that may be connected to computer 500. For example, I/O interface 514 may provide a connection to external devices 520 such as a keyboard, keypad, a touch screen, and/or some other suitable input device. External devices 520 can also include portable computer-readable storage media such as, for example, thumb drives, portable optical or magnetic disks, and memory cards. Software and data used to practice embodiments of the present invention can be stored on such portable computer-readable storage media and can be loaded onto persistent storage 508 via I/O interface(s) 514. I/O interface(s) 514 also connect to a display 522.

Display 522 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer implemented method comprising:
identifying, by one or more processors, a set of available system resources;
defining, by one or more processors, a set of virtual resource pools;
assigning, by one or more processors, one or more system resources of the set of identified system resources to one or more virtual pools of the set of virtual resource pools;
creating, by one or more processors, a plurality of logical partitions within a first virtual resource pool of the set of virtual resource pools, wherein each logical partition of the plurality of logical partitions specifies a weight relative to other partitions in the first virtual resource pool;
receiving, by one or more processors, a request for additional resources from the first virtual resource pool; and
allowing, by one or more processors, the first virtual pool to access an unused resource from a second virtual resource pool of the set of virtual resource pools.

2. The computer implemented method of claim 1, wherein the set of available system resources corresponds to a set of available processors.

3. The computer implemented method of claim 2, wherein the processors are Integrated Facility for Linux (IFL) processors.

4. The computer implemented method of claim 1, further comprising creating a plurality of logical partitions within the second virtual resource pool of the set of virtual resource pools, wherein each logical partition of the plurality of logical partitions within the second virtual resource pool specifies a weight relative to other partitions in the second virtual resource pool.

5. The computer implemented method of claim 4, further comprising modifying one or more features of the plurality of logical partitions within the second virtual resource pool.

6. The computer implemented method of claim 5, wherein a state of the features of the logical partitions of the first virtual pool is independent from any changes resultant from the modifying of one or more features of the plurality of logical partitions within the second virtual resource pool.

7. The computer implemented method of claim 4, wherein modifying one or more features of the plurality of logical partitions within the second virtual resource pool includes adjusting the specified weight of one or more partitions of the plurality of logical partitions within the second virtual resource pool.

8. A computer program product comprising:
one or more computer readable storage media and program instructions stored on the one or more computer readable storage media, the program instructions comprising instructions to:
identify a set of available system resources;
define a set of virtual resource pools;
assign one or more system resources of the set of identified system resources to one or more virtual pools of the set of virtual resource pools,
create a plurality of logical partitions within a first virtual resource pool of the set of virtual resource pools, wherein each logical partition of the plurality of logical partitions specifies a weight relative to other partitions in the first virtual resource pool;
receive a request for additional resources from the first virtual resource pool; and
allow the first virtual pool to access an unused resource from a second virtual resource pool of the set of virtual resource pools.

9. The computer program product of claim 8, wherein the set of available system resources corresponds to a set of available processors.

10. The computer program product of claim 9, wherein the processors are Integrated Facility for Linux (IFL) processors.

11. The computer program product of claim 8, the program instructions further comprising instructions to create a plurality of logical partitions within the second virtual resource pool of the set of virtual resource pools, wherein each logical partition of the plurality of logical partitions within the second virtual resource pool specifies a weight relative to other partitions in the second virtual resource pool.

12. The computer program product of claim 11, the program instructions further comprising instructions to modify one or more features of the plurality of logical partitions within the second virtual resource pool.

13. The computer program product of claim 12, wherein a state of the features of the logical partitions of the first virtual pool is independent from any changes resultant from the modifying of one or more features of the plurality of logical partitions within the second virtual resource pool.

14. The computer program product of claim 11, wherein the program instructions to modify one or more features of the plurality of logical partitions within the second virtual resource pool comprise instructions to adjust the specified weight of one or more partitions of the plurality of logical partitions within the second virtual resource pool.

15. A computer system comprising:
one or more computer processors;
one or more computer-readable storage media;
program instructions stored on the computer-readable storage media for execution by at least one of the one or more processors, the program instructions comprising instructions to:
identify a set of available system resources;
define a set of virtual resource pools;
assign one or more system resources of the set of identified system resources to one or more virtual pools of the set of virtual resource pools,
create a plurality of logical partitions within a first virtual resource pool of the set of virtual resource pools, wherein each logical partition of the plurality of logical partitions specifies a weight relative to other partitions in the first virtual resource pool;
receive a request for additional resources from the first virtual resource pool; and
allow the first virtual pool to access an unused resource from a second virtual resource pool of the set of virtual resource pools.

16. The computer system of claim 15, wherein the set of available system resources corresponds to a set of available processors.

17. The computer system of claim 15, the program instructions further comprising instructions to create a plurality of logical partitions within the second virtual resource pool of the set of virtual resource pools, wherein each logical partition of the plurality of logical partitions within the second virtual resource pool specifies a weight relative to other partitions in the second virtual resource pool.

18. The computer system of claim 17, the program instructions further comprising instructions to modify one or more features of the plurality of logical partitions within the second virtual resource pool.

19. The computer system of claim 18, wherein a state of the features of the logical partitions of the first virtual pool is independent from any changes resultant from the modifying of one or more features of the plurality of logical partitions within the second virtual resource pool.

20. The computer system of claim 18, wherein the program instructions to modify one or more features of the plurality of logical partitions within the second virtual resource pool comprise instructions to adjust the specified weight of one or more partitions of the plurality of logical partitions within the second virtual resource pool.
